(19) United States
(12) Patent Application Publication
(10) Pub. No.: US 2013/0107517 A1
(43) Pub. Date: May 2, 2013

(54) LIGHT EMITTING DIODE BULB

(71) Applicants: Wei-Wen SHIH, Longtan Township (TW); Wen-Kwei LIANG, Longtan Township (TW)

(72) Inventors: Wei-Wen SHIH, Longtan Township (TW); Wen-Kwei LIANG, Longtan Township (TW)

(73) Assignee: LEOTEK ELECTRONICS CORPORATION, Longtan Township (TW)

(21) Appl. No.: 13/286,381

(22) Filed: Nov. 1, 2011

(51) Int. Cl. F21V 7/00

(52) U.S. Cl. 362/235

(57) ABSTRACT

A Light Emitting Diode (LED) bulb includes a circuit board assembly, a base, a first LED light source module and a second LED light source module disposed on two opposite surfaces of the circuit board assembly, and a shell. The base includes a reflective surface. After passing through the shell, a first light beam emitted by the first LED light source module and a direct light beam emitted by the second LED light source module respectively form a first light distribution pattern and a third light distribution pattern. After being reflected by the reflective surface and emitted from the shell, a reflected light beam emitted by the second LED light source module forms a second light distribution pattern. The first light distribution pattern, the second light distribution pattern, and the third light distribution pattern superpose to each other to form an omni-directional light distribution pattern.

### BACKGROUND

1. Technical Field

The present disclosure relates to a Light Emitting Diode (LED) bulb, and more particularly to an LED bulb having an omni-directional light distribution pattern.

2. Related Art

With the booming development of technology and increasing awareness of environmental protection, incandescent light bulbs are likely to be replaced due to defects such as low light emitting efficiency, high power consumption, and a short service life. In recent years, an LED becomes one of major lighting sources applied in daily life since the LED have advantages such as a long service life, low power consumption, quick response, high impact resistance, high weather adaptability, small volume, high light emitting efficiency, and light weight.

FIG. 1 shows light distribution patterns of a conventional incandescent light bulb on a first plane, a second plane, and a third plane. Referring to FIG. 1, a conventional incandescent light bulb is positioned at a central position Q. Each concentric circle represents a contour with different light intensity. Each radiating line represents an angle between the radiating line and a vertical axis (that is, a 0° radiating line). The first plane is a 0°-180° section of the conventional incandescent light bulb and the light distribution pattern on the first plane is a light distribution pattern represented by a solid line in FIG. 1. The second plane is a 45°-225° section of the conventional incandescent light bulb and the light distribution pattern on the second plane is a light distribution pattern represented by a centerline in FIG. 1. The third plane is a 90°-270° section of the conventional incandescent light bulb and the light distribution pattern on the third plane is a light distribution pattern represented by a broken line in FIG. 1. According to FIG. 1, it can be seen that the conventional incandescent light bulb is an omni-directional light source. However, due to structural factors such as packaging of the LED, light emitted by the LED is generally limited within a certain range (because the LED is highly directional) so the LED cannot completely replace the incandescent light bulb in daily life.

### SUMMARY

According to an embodiment of an LED bulb of the disclosure, an LED bulb includes a circuit board assembly, a base, a first LED light source module, a second LED light source module, and a shell. The base includes a reflective surface. The circuit board assembly includes a first surface and a second surface opposite to each other. The first LED light source module is disposed on the first surface. The second LED light source module is disposed on the second surface. The shell is joined to the base. The first LED light source module is used for emitting a first light beam. The second LED light source module is used for emitting a second light beam. The second light beam includes a reflected light beam and a direct light beam. After passing through the shell, the first light beam forms a first light distribution pattern. After being reflected by the reflective surface and emitted from the shell, the reflected light beam forms a second light distribution pattern. After passing through the shell, the direct light beam forms a third light distribution pattern. The first light distribution pattern, the second light distribution pattern, and the third light distribution pattern superpose to each other. The superposition of the first light distribution pattern, the second light distribution pattern, and the third light distribution pattern forms an omni-directional light distribution pattern.

According to an embodiment of the LED bulb of the disclosure, an LED bulb includes a circuit board assembly, a base, a first LED light source module, a second LED light source module, and a shell. The circuit board assembly includes a first surface and a second surface opposite to each other. The shell includes a reflective surface. The first LED light source module is disposed on the first surface, and the first LED light source module is used for emitting a first light beam. The second LED light source module is disposed on the second surface. The second LED light source module is used for emitting a second light beam. The second light beam includes a reflected light beam and a direct light beam. The shell is joined to the base. After passing through the shell, the first light beam forms a first light distribution pattern. After being reflected by the reflective surface and emitted from the shell, the reflected light beam forms a second light distribution pattern. After passing through the shell, the direct light beam forms a third light distribution pattern. The first light distribution pattern, the second light distribution pattern, and the third light distribution pattern superpose each other. The superposition of the first light distribution pattern, the second light distribution pattern, and the third light distribution pattern forms an omni-directional light distribution pattern.

### BRIEF DESCRIPTION OF THE DRAWINGS

The present disclosure will become more fully understood from the detailed description given herein below for illustration only, and thus are not limitative of the present disclosure, and wherein:

FIG. 1 shows light distribution patterns of a conventional incandescent light bulb on a first plane, a second plane, and a third plane;

FIG. 2A is a schematic perspective view of an LED bulb according to a first embodiment of the disclosure;

FIG. 2B is a schematic sectional structural view of the LED bulb according to an embodiment in FIG. 2A;

FIG. 2C is a schematic sectional structural view of an LED bulb according to a second embodiment of the disclosure;

FIG. 3A is a schematic view of a first light distribution pattern of the LED bulb according to an embodiment in FIG. 2B;

FIG. 3B is a schematic view of a second light distribution pattern of the LED bulb according to an embodiment in FIG. 2B;

FIG. 3C is a schematic view of a third light distribution pattern of the LED bulb according to an embodiment in FIG. 2B;

FIG. 3D is a schematic view of an omni-directional light distribution pattern of the LED bulb according to an embodiment in FIG. 2B;

FIG. 4A is a schematic structural view of a first LED light source module being disposed on a first surface according to an embodiment in FIG. 2B;

FIG. 4B is a schematic structural view of a second LED light source module being disposed on a second surface according to an embodiment in FIG. 2B;

FIG. 5A is a schematic structural view of a first LED package structure according to an embodiment in FIG. 2B;

FIG. 5B is a schematic structural view of a second LED package structure according to an embodiment in FIG. 2B;

FIG. 6A shows light distribution patterns on a first plane and a third plane when a ratio between a first luminous flux and a second luminous flux of the LED bulb is 0.1 in FIG. 2B;

FIG. 6B shows light distribution patterns on the first plane and the third plane when the ratio between the first luminous flux and the second luminous flux of the LED bulb is 0.2 in FIG. 2B;

FIG. 6C shows light distribution patterns on the first plane and the third plane when the ratio between the first luminous flux and the second luminous flux of the LED bulb is 0.3 in FIG. 2B;

FIG. 6D shows light distribution patterns on the first plane and the third plane when the ratio between the first luminous flux and the second luminous flux of the LED bulb is 0.5 in FIG. 2B;

FIG. 6E shows light distribution patterns on the first plane and the third plane when the ratio between the first luminous flux and the second luminous flux of the LED bulb is 0.7 in FIG. 2B;

FIG. 6F shows light distribution patterns on the first plane and the third plane when the ratio between the first luminous flux and the second luminous flux of the LED bulb is 1.0 in FIG. 2B;

FIG. 6G shows light distribution patterns on the first plane and the third plane when the ratio between the first luminous flux and the second luminous flux of the LED bulb is 1.5 in FIG. 2B;

FIG. 7 is a schematic sectional structural view of an LED bulb according to a third embodiment of the disclosure;

FIG. 8 is a schematic sectional structural view of an LED bulb according to a fourth embodiment of the disclosure;

FIG. 9A is a schematic structural view of a first LED light source module according to an embodiment in FIG. 8;

FIG. 9B is a schematic structural view of a second LED light source module according to an embodiment in FIG. 8;

FIG. 10 is a schematic sectional structural view of an LED bulb according to a fifth embodiment of the disclosure;

FIG. 11A is a schematic structural view of a first LED light source module being disposed on a first surface according to an embodiment in FIG. 10;

FIG. 11B is a schematic structural view of a second LED light source module being disposed on a second surface according to an embodiment in FIG. 10; and

FIG. 12 is a schematic sectional structural view of an LED bulb according to a sixth embodiment of the disclosure.

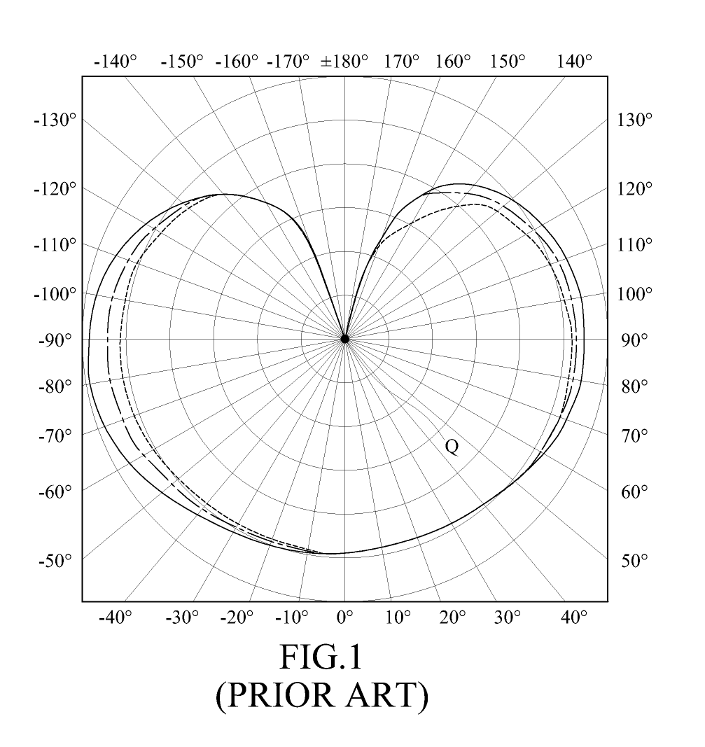

### DETAILED DESCRIPTION

Accordingly, the present disclosure discloses an LED bulb, for solving the problem that an LED cannot completely replace an incandescent light bulb.

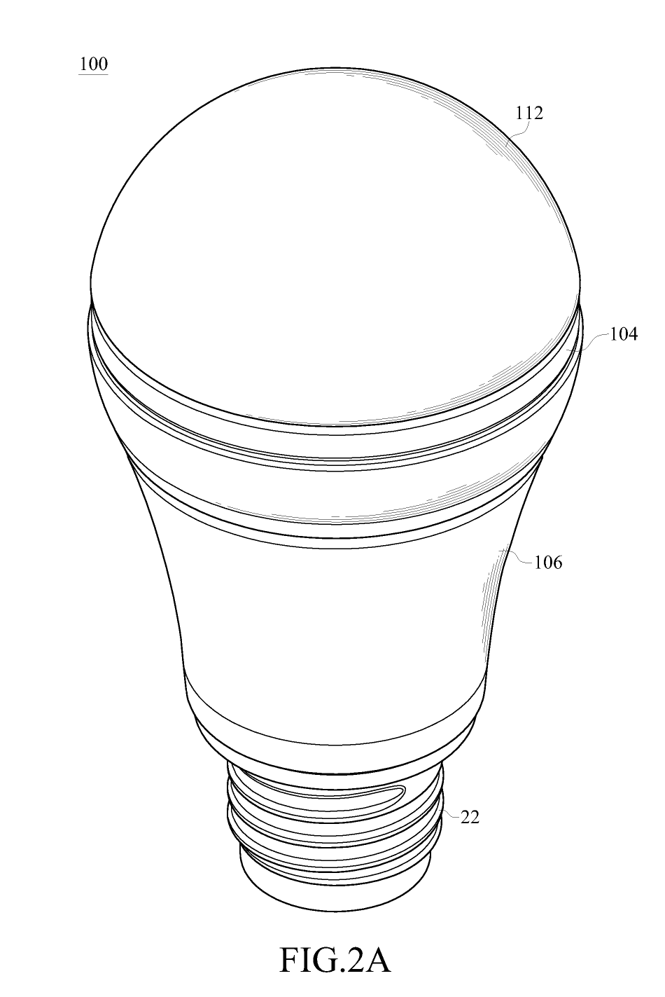

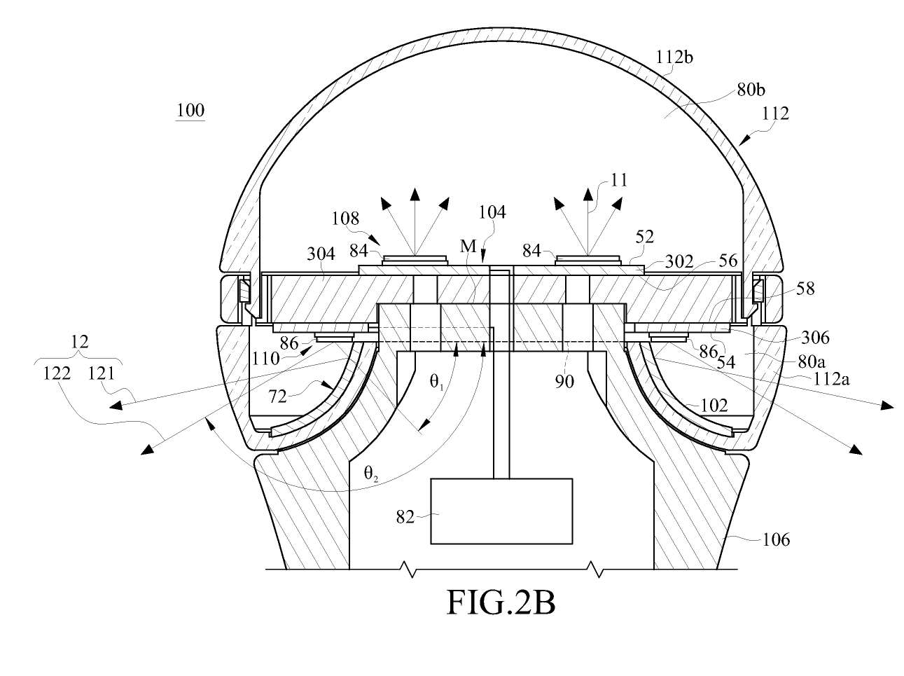

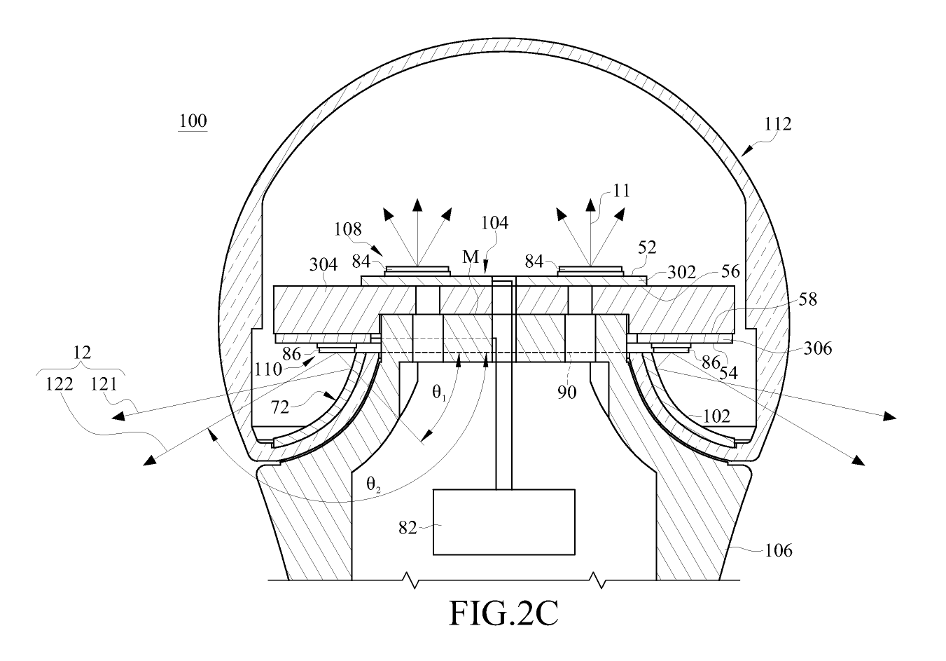

FIG. 2A is a schematic perspective view of an LED bulb according to a first embodiment of the disclosure. As shown in FIG. 2A, an LED bulb 100 includes a bulb connector 22, a circuit board assembly 104, a base 106, and a shell 112, but is not limited to the above-mentioned elements. In this embodiment, the base 106 is used for dissipating heat generated by the LED bulb 100 when the LED bulb 100 is turned on. The bulb connector 22 is connected to an external power supply (not shown) for supplying power to the LED bulb 100. The bulb connector 22 is a screw type bulb connector, but is not limited to the above-mentioned connector. The base 106 is made of aluminum, but is not limited to the above-mentioned material. The shell 112 is made of transparent glass, but is not limited to the above-mentioned material. For example, in some embodiments, the bulb connector 22 is a GU10 type bulb connector, the base 106 is made of copper, and the shell 112 is made of transparent plastic.

FIG. 2B is a schematic sectional structural view of the LED bulb according to an embodiment in FIG. 2A. As shown in FIG. 2A and FIG. 2B, the LED bulb 100 includes the circuit board assembly 104, the base 106, a first LED light source module 108, a second LED light source module 110, and the shell 112. The circuit board assembly 104 includes a first surface 52 and a second surface 54 opposite to each other. The first LED light source module 108 is disposed on the first surface 52. The second LED light source module 110 is disposed on the second surface 54, and the second LED light source module 110 surrounds a joint M. The joint M is a joint between the base 106 and the circuit board assembly 104. The shell 112 is joined to the base 106, and the shell 112 includes a reflective surface 72. The reflective surface 72 is formed by disposing a reflective unit 102 on the shell 112.

In this embodiment, the shell 112 further includes a first shell 112a and a second shell 112b. The first shell 112a is joined to the base 106 and the circuit board assembly 104, to form a first accommodation space 80a. The second LED light source module 110 and the reflective unit 102 are disposed in the first accommodation space 80a. The second shell 112b is joined to the circuit board assembly 104, to form a second accommodation space 80b. The first LED light source module 108 is disposed in the second accommodation space 80b. However, this embodiment is not intended to limit the present disclosure. For example, in some embodiments, the LED bulb 100 only includes a single shell 112 (referring to FIG. 2C, FIG. 2C is a schematic sectional structural view of a second embodiment of the LED bulb according to the disclosure).

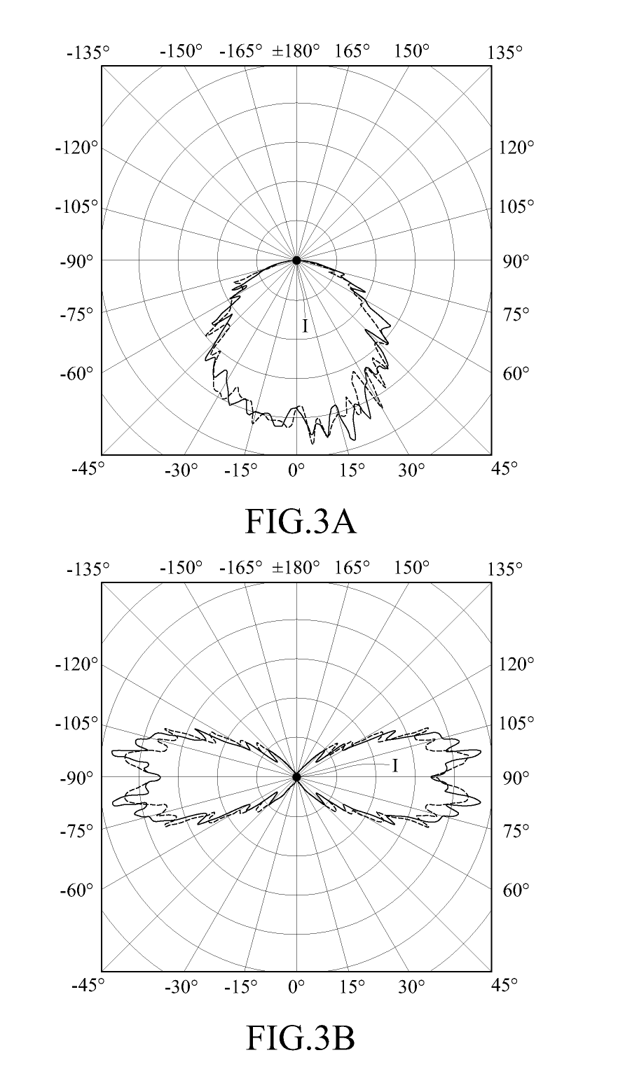

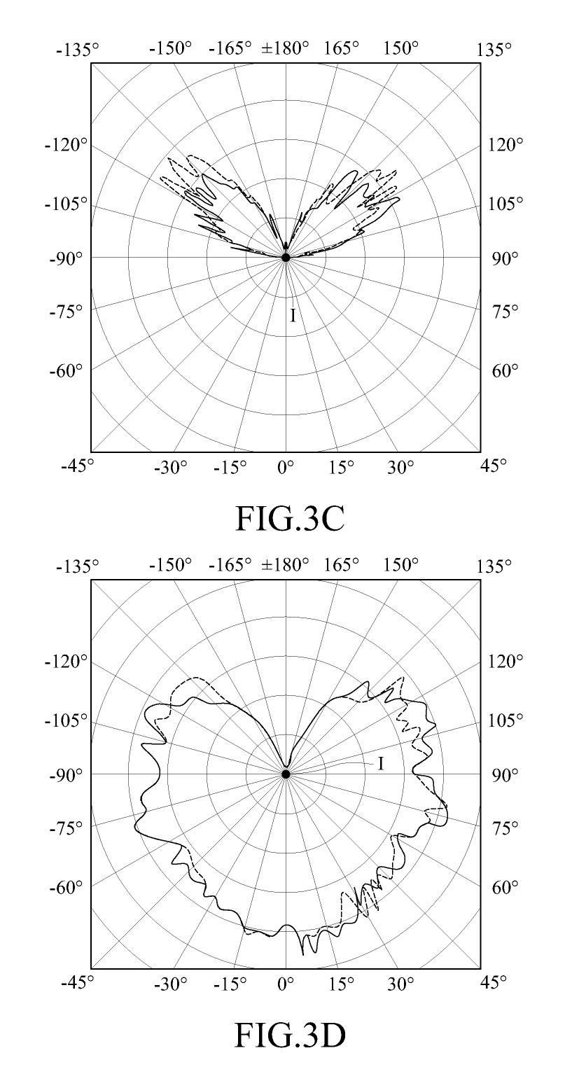

The first LED light source module 108 is used for emitting a first light beam 11. The second LED light source module 110 is used for emitting a second light beam 12. The second light beam 12 includes a reflected light beam 121 and a direct light beam 122. After passing through the second shell 112b, the first light beam 11 forms a first light distribution pattern (referring to FIG. 3A, FIG. 3A is a schematic view of a first light distribution pattern of the LED bulb according to an embodiment in FIG. 2B). After being reflected by the reflective surface 72 and emitted from the shell 112, the reflected light beam 121 forms a second light distribution pattern (referring to FIG. 3B, FIG. 3B is a schematic view of a second light distribution pattern of the LED bulb according to an embodiment in FIG. 2B). After passing through the shell 112, the direct light beam 122 forms a third light distribution pattern (referring to FIG. 3C, FIG. 3C is a schematic view of a third light distribution pattern of the LED bulb according to an embodiment of FIG. 2B). The first light distribution pattern, the second light distribution pattern, and the third light distribution pattern superpose to each other. The superposition of the first light distribution pattern, the second light distribution pattern, and the third light distribution pattern forms an omni-directional light distribution pattern (referring to FIG. 3D, a schematic view of an omni-directional light distribution pattern of the LED bulb according to an embodiment of FIG. 2B).

In this embodiment, the first LED light source module 108 has a first luminous flux L₁, the second LED light source module 110 has a second luminous flux L₂, and the LED bulb 100 further includes a control unit 82, but is not limited thereto. The control unit 82 is used for controlling the first luminous flux L₁ and the second luminous flux L₂.

The second LED light source module 110 further has a reference axis 90. The reference axis 90 and the second surface 54 are parallel. In this embodiment, a first angle θ₁ between the reflected light beam 121 and the reference axis 90 ranges from 0° to 120°, but is not limited to the above-mentioned range, and the reflected light beam 121 is reflected by the reflective surface 72 and emitted from the first shell 112a, so the reflected light beam 121 forms the second light distribution pattern (as shown in FIG. 3B). A second angle θ₂ between the direct light beam 122 and the reference axis 90 ranges from 120° to 180°, but is not limited to the above-mentioned range, and the direct light beam 122 is directly emitted from the first shell 112a, so the direct light beam 122 forms the third light distribution pattern (as shown in FIG. 3C).

In addition, the circuit board assembly 104 includes a first circuit board 302, a substrate 304, and a second circuit board 306, but is not limited thereto. The first circuit board 302 and the second circuit board 306 are disposed on two opposite sides of the substrate 304. Specifically, the first circuit board 302 includes the first surface 52 and a third surface 56. The second circuit board 306 includes the second surface 54 and a fourth surface 58. The third surface 56 and the fourth surface 58 are disposed on the two opposite sides of the substrate 304 respectively. The substrate 304 facilitates the heat dissipation of the first circuit board 202 and the second circuit board 204. The substrate 304 is made of aluminum or copper, but is not limited to the above-mentioned material.

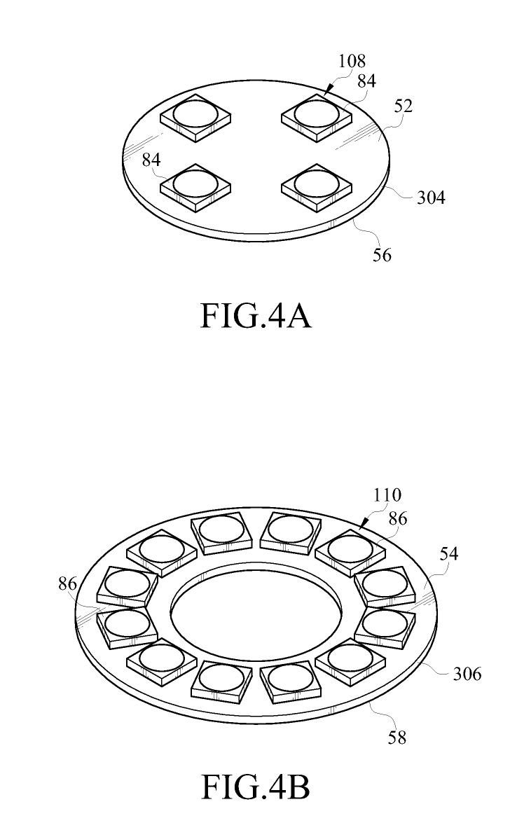

FIG. 4A is a schematic structural view of the first LED light source module being disposed on the first surface according to an embodiment in FIG. 2B. FIG. 4B is a schematic structural view of the second LED light source module being disposed on the second surface according to an embodiment in FIG. 2B. The first LED light source module 108 includes four first LED package structures 84, but is not limited thereto. Each of the first LED package structures 84 is disposed on the first surface 52. The second LED light source module 110 includes twelve second LED package structures 86, but is not limited thereto. Each of the second LED package structures 86 is disposed on the second surface 54 and the second LED package structures 86 surrounds the joint M (referring to FIG. 2B). The number of the first LED package structures 84 includes by the first LED light source module 108 and the number of the second LED package structures 86 included by the second LED light source module 110 may be adjusted according to actual needs.

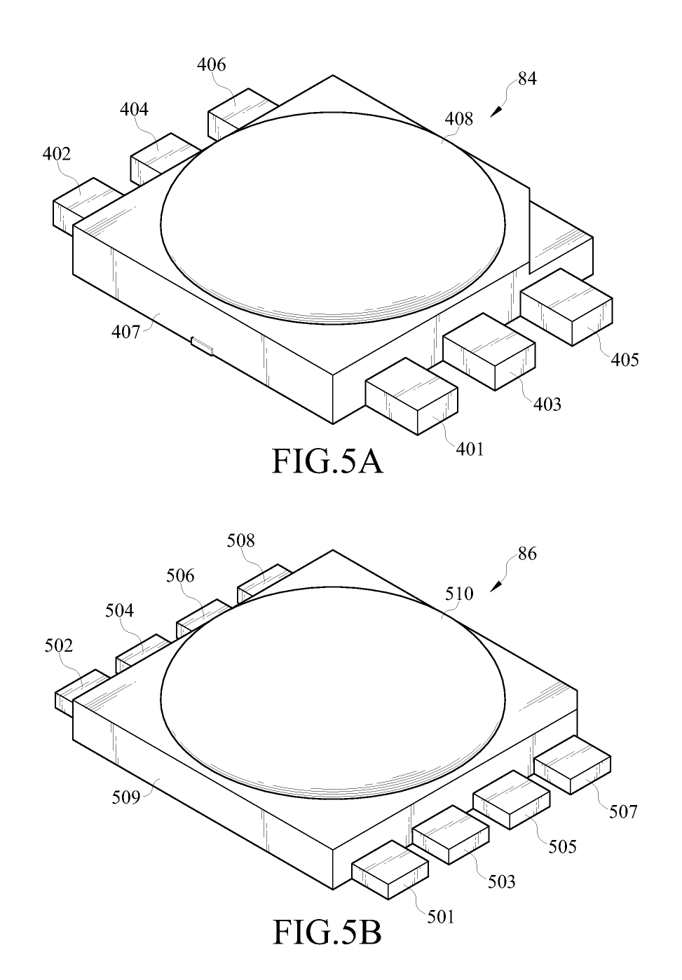

FIG. 5A is a schematic structural view of the first LED package structure according to an embodiment in FIG. 2B. The first LED package structure 84 is a Red Green Blue (RGB) LED, but is not limited to the above-mentioned structure, and the first LED package structure 84 includes first anodes 402, 404, and 406, first cathodes 401, 403, and 405, a red light LED chip (not shown), a green light LED chip (not shown), a blue light LED chip (not shown), a first body 407, and a lens 408. The first anodes 402, 404, and 406 and the first cathodes 401, 403, and 405 are electrically connected to the first circuit board 302. The first body 407 covers and protects the red light LED chip, the green light LED chip, and the blue light LED chip. The lens 408 is used for controlling travel directions of red light emitted by the red light LED chip, green light emitted by the green light LED chip, and blue light emitted by the blue light LED chip. The first anode 402 and the first cathode 401 are used for driving the red light LED chip to emit the red light. The first anode 404 and the first cathode 403 are used for driving the green light LED chip to emit the green light. The first anode 406 and the first cathode 405 are used for driving the blue light LED chip to emit the blue light. It should be noted that, the first LED light source module 108 controls, with the control unit 82 (referring to FIG. 3B), a color of the first light beam 11 emitted by each of the first LED package structures 84, which, for example, is red, yellow or white, but is not limited to the above-mentioned colors.

FIG. 5B is a schematic structural view of the second LED package structure according to an embodiment in FIG. 2B. As shown in FIG. 5B, the second LED package structure 86 is a Red Green Blue White (RGBW) LED, but is not limited to the above-mentioned structure, and includes second anodes 502, 504, 506, and 508, second cathodes 501, 503, 505, and 507, a red light LED chip (not shown), a green light LED chip (not shown), a blue light LED chip (not shown), a white light LED chip (not shown), a second body 509, and a lens 510. The second anodes 502, 504, 506, and 508, and the second cathodes 501, 503, 505, and 507 are electrically connected to the second circuit board 306. The second body 509 covers and protects the red light LED chip, the green light LED chip, the blue light LED chip, and the white light LED chip. The lens 510 is used for controlling travel directions of red light emitted by the red light LED chip, green light emitted by the green light LED chip, blue light emitted by the blue light LED chip, and white light emitted by the white light LED chip. The second anode 502 and the second cathode 501 are used for driving the red light LED chip to emit the red light. The second anode 504 and the second cathode 503 are used for driving the green light LED chip to emit the green light. The second anode 506 and the second cathode 505 are used for driving the blue light LED chip to emit the blue light. The second anode 508 and the second cathode 507 are used for drive the white light LED chip to emit the white light. It should be noted that, the second LED light source module 110 controls, with the control unit 82 (referring to FIG. 3B), a color of the second light beam 12 emitted by each of the second LED package structures 86, which, for example, is red, yellow or white, but is not limited to the above-mentioned colors.

In this embodiment, the first LED package structures 84 and the second LED package structures 86 are RGB LEDs and RGBW LEDs, respectively, but this embodiment is not intended to limit the present disclosure. For example, the first LED package structures 84 and the second LED package structures 86 are the RGB LEDs at the same time or the first LED package structures 84 and the second LED package structures 86 are the RGBW LEDs at the same time.

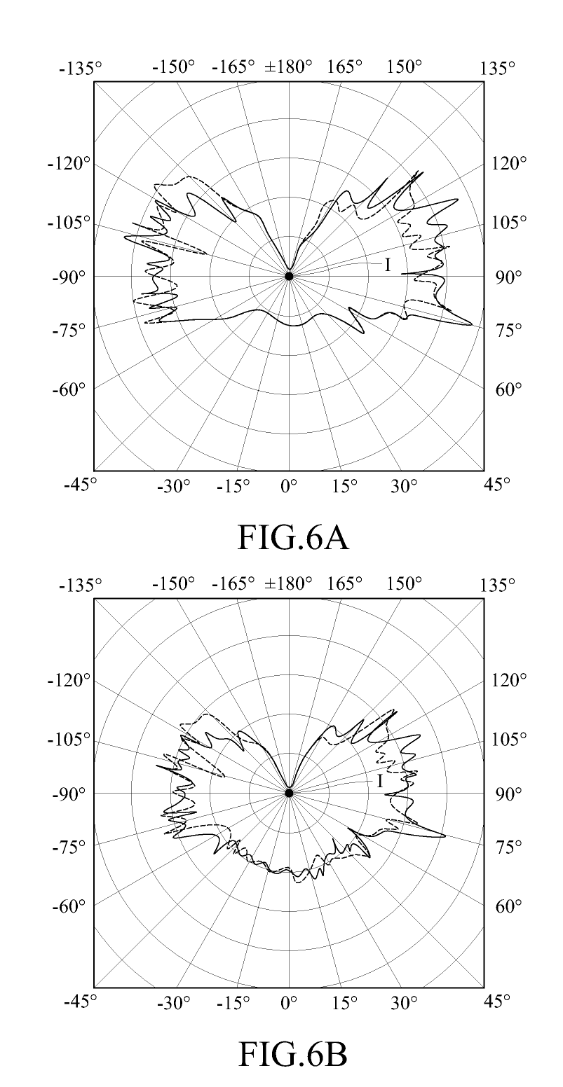

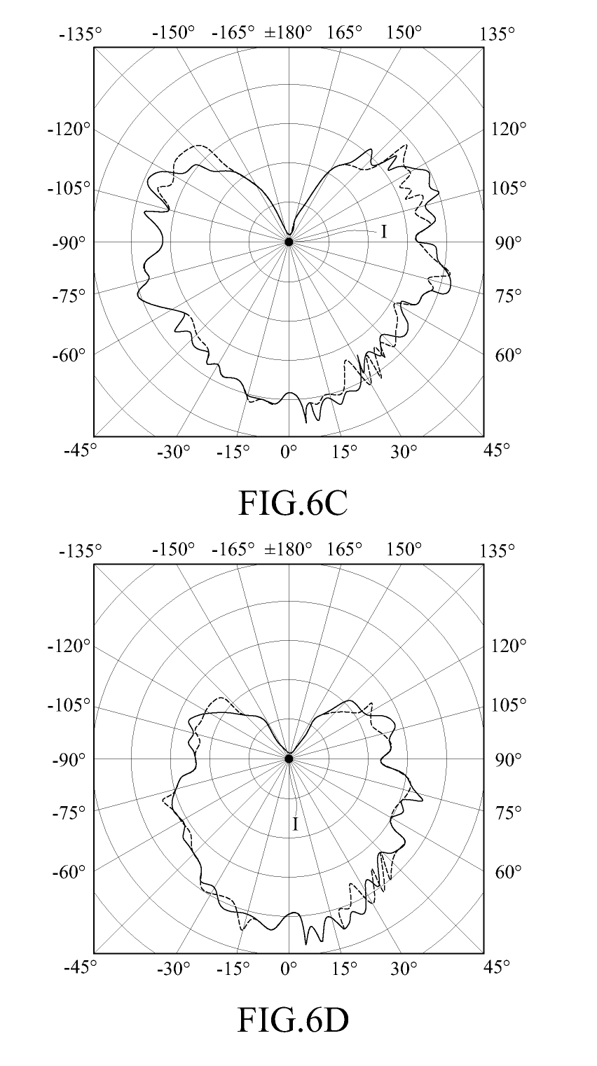

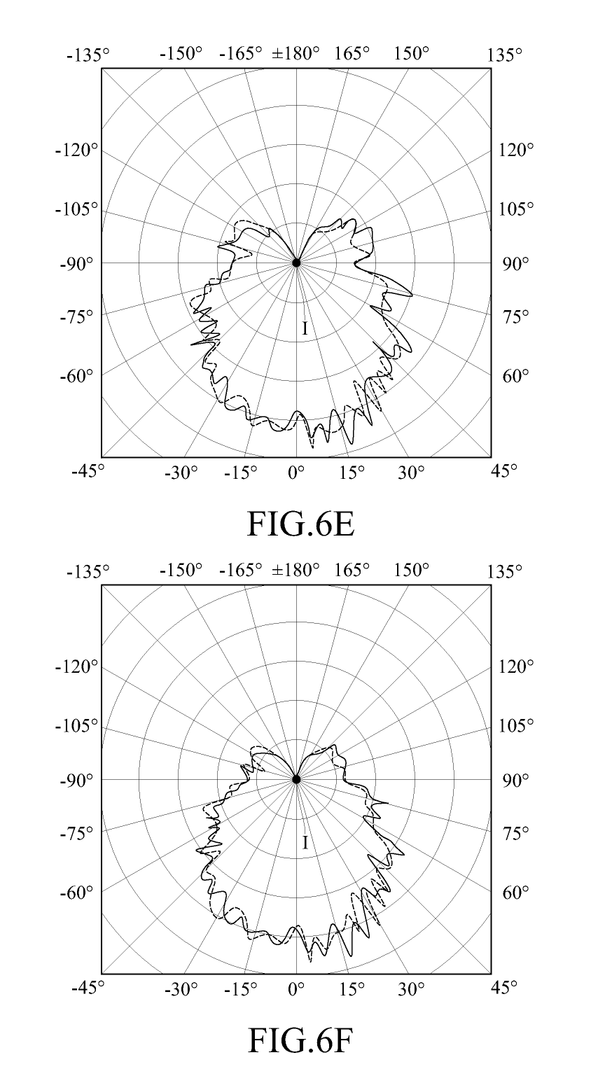

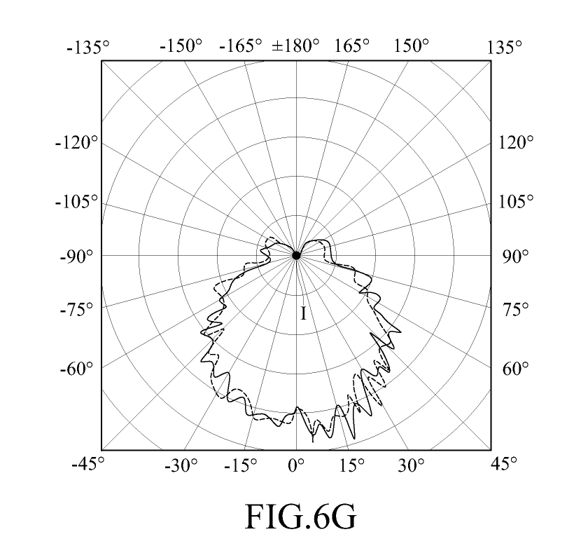

The following experiment is performed according to this embodiment. FIG. 6A to FIG. 6G respectively show light distribution patterns on a first plane and a third plane when ratios between the first luminous flux and the second luminous flux of the LED bulb in FIG. 2B are 0.1, 0.2, 0.3, 0.5, 0.7, 1.0, and 1.5. In FIG. 6A to FIG. 6G, the LED bulb 100 is positioned at a central position I, each of concentric circles represents a light intensity contour, and each of radiating lines represents an angle between the radiating line and a vertical axis (that is, a 0° radiating line). The first plane is a 0°-180° section of the LED bulb 100, and the light distribution patterns on the first plane are light distribution patterns represented by solid lines in FIG. 6A to FIG. 6G. The third plane is a 90°-270° section of the LED bulb 100, and the light distribution patterns on the third plane are light distribution patterns represented by broken lines in FIG. 6A to FIG. 6G.

According to FIG. 6A to FIG. 6G, when the ratio between the first luminous flux L₁ and the second luminous flux L₂ becomes closer to 0.1 (that is, the second LED light source module 110 is a major light source of the LED bulb 100), for the LED bulb 100, no matter in the light distribution pattern on the first plane or on the third plane, the light intensity thereof within a range from −75° to 75° across ±180° becomes much greater than light intensity within a range from −75° to 75° across 0°.

In addition, Table 1 shows average illuminance and a uniformity when the LED bulb, with the ratio between the first luminous flux and the second luminous flux being 0.1, 0.2, 0.3, 0.5, 0.7, 1.0, and 1.5, in FIG. 2B is disposed at the same height and illustrates the same working plane. The LED bulb 100 is disposed at a position 2.8 meters (m) away from a floor and disposed above a geometric center of the working plane. The working plane has an area of 5 m×5 m and is 85 centimeters (cm) away from the floor. The average illuminance is an average value of the illuminance at multiple measured points on the working plane. The uniformity is a ratio between the minimum illuminance and the average illuminance at all the measured points.

TABLE 1

| | Ratio between the first luminous flux and | | | | | | |
|---|---|---|---|---|---|---|---|
| | the second luminous flux | | | | | | |
| | 0.1 | 0.2 | 0.3 | 0.5 | 0.7 | 1.0 | 1.5 |
| Average | 8.75 | 11 | 13 | 16 | 19 | 21 | 24 |
| illumi- | | | | | | | |
| nance | | | | | | | |
| (lux) | | | | | | | |
| Uni- | 0.675 | 0.551 | 0.496 | 0.432 | 0.401 | 0.367 | 0.35 |
| formity | | | | | | | |

According to Table 1, it can be seen that when the ratio between the first luminous flux L₁ and the second luminous flux L₂ becomes closer to 0.1, the uniformity of the LED bulb 100 becomes greater, which is applicable to indoor illumination. When the ratio between the first luminous flux L₁ and the second luminous flux L₂ becomes closer to 1.5, the average illuminance of the LED bulb 100 becomes greater, which is applicable to night illumination.

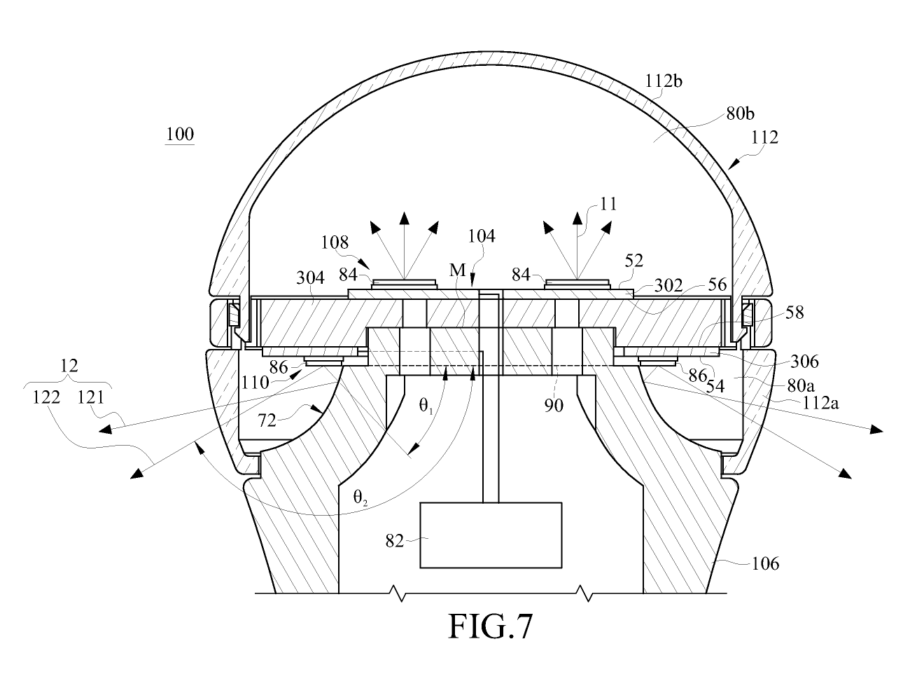

The shell 112 according to the first embodiment includes the reflective surface 72, but the first embodiment is not intended to limit the present disclosure. In other words, the reflective surface 72 are disposed on the base 106 (referring to FIG. 7, FIG. 7 is a schematic sectional structural view of the LED bulb according to a third embodiment of the present disclosure).

Referring to FIG. 7, the LED bulb 100 includes a circuit board assembly 104, a base 106, a first LED light source module 108, a second LED light source module 110, and a shell 112. The base 106 includes a reflective surface 72. The circuit board assembly 104 includes a first surface 52 and a second surface 54 opposite to each other. The first LED light source module 108 is disposed on the first surface 52. The second LED light source module 110 is disposed on the second surface 54, and the second LED light source module 110 surrounds the joint M. The joint M is a joint between the base 106 and the circuit board assembly 104. The shell 112 is joined to the base 106. In this embodiment, the base 106 is made of metal having a polished surface, so the base 106 has the reflective surface 72.

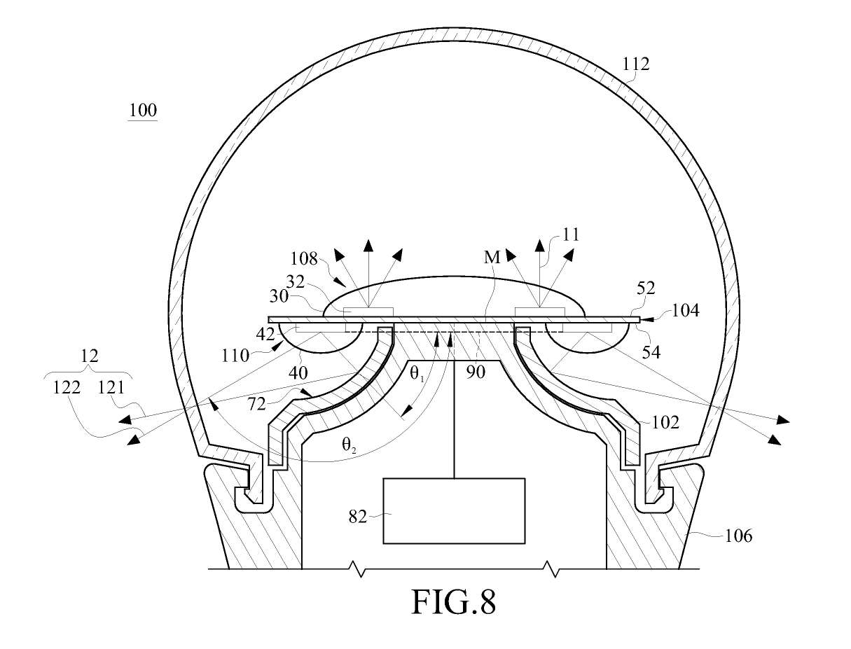

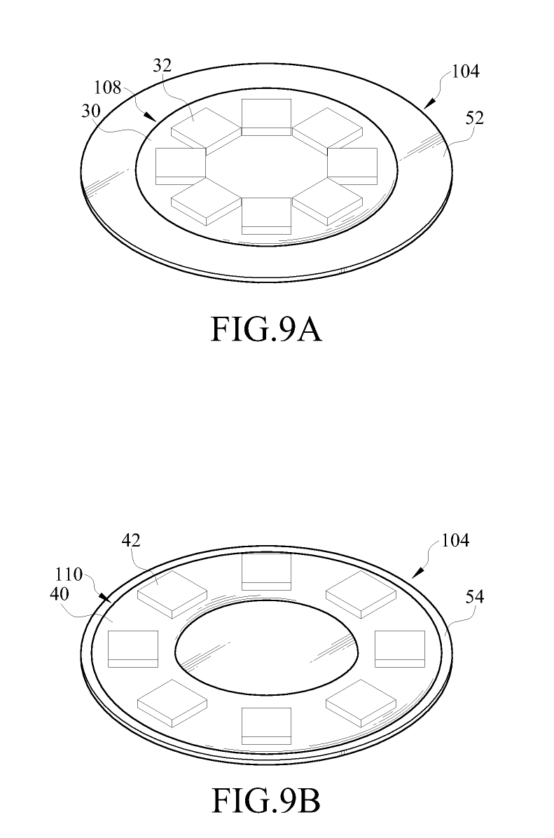

The circuit board assembly 104 according to the first embodiment, the second embodiment, and the third embodiment includes two single-surface circuit boards (the first circuit board 302 and the second circuit board 306), but is not limited thereto. In other words, the circuit board assembly 104 is a double-sided circuit board. In the first LED light source module 108, a first LED chip 32 is disposed between a first package body 30 and the first surface 52 through a Chip On Board (COB) process. In the second LED light source module 110, a second LED chip 42 is disposed between a second package body 40 and the second surface 54 through the COB process (referring to FIG. 8, FIG. 9A, and FIG. 9B, FIG. 8 is a schematic sectional structural view of the LED bulb according to a fourth embodiment of the present disclosure, FIG. 9A is a schematic structural view of the first LED light source module according to an embodiment in FIG. 8, and FIG. 9B is a schematic structural view of the second LED light source module according to an embodiment in FIG. 8).

As shown in FIG. 8, the LED bulb 100 includes a circuit board assembly 104, a base 106, a first LED light source module 108, a second LED light source module 110, and a shell 112. The base 106 includes a reflective unit 102. The reflective unit 102 has a reflective surface 72. The circuit board assembly 104 includes a first surface 52 and a second surface 54 opposite to each other. The reflective unit 102 is disposed at the base 106. The first LED light source module 108 is disposed on the first surface 52. The second LED light source module 110 is disposed on the second surface 54, and the second LED light source module 110 surrounds the joint M. The joint M is a joint between the base 106 and the circuit board assembly 104. The shell 112 is joined to the base 106.

Referring to FIG. 9A and FIG. 9B, the circuit board assembly 104 is a double-sided round circuit board, but is not limited to the above-mentioned circuit board. That is to say, the circuit board assembly 104 is a double-sided square circuit board. The first LED light source module 108 includes eight first LED chips 32 and the first package body 30, but this embodiment is not intended to limit the present disclosure. That is to say, the first LED light source module 108 includes ten first LED chips 32. The number of the first LED chips 32 included by the first LED light source module 108 may be adjusted according to actual needs. Each of the first LED chips 32 is disposed between the first package body 30 and the first surface 52 (that is, the first LED light source module 108 is disposed on the first surface 52 of the circuit board assembly 104 through the COB process), and the first LED chips 32 is disposed on the first surface 52 in a circular arrangement, but this embodiment is not intended to limit the disclosure. In other words, the first LED chips 32 are disposed on the first surface 52 in an array arrangement. The arrangement of the first LED chips 32 may be adjusted according to actual needs. The first LED chips 32 all are the red light LED chips, but this embodiment is not intended to limit the disclosure. That is to say, the first LED chips 32 partially are the red light LED chips, partially are the blue light LED chips, and partially are the green light LED chips, which are adjusted according to actual needs.

The second LED light source module 110 includes eight second LED chips 42 and a second package body 40, but this embodiment is not intended to limit the disclosure. That is to say, the second LED light source module 110 includes ten second LED chips 42. The number of the second LED chips 42 included by the second LED light source module 110 may be adjusted according to actual needs. Each of the second LED chips 42 is disposed between the second package body 40 and the second surface 54 (that is, the second LED light source module 110 is disposed on the second surface 54 of the circuit board assembly 104 through the COB process), and the second LED chips 42 are arranged in a ring arrangement to surround the joint M, but this embodiment is not intended to limit the disclosure. In other words, the second LED chips 42 are arranged in a square arrangement to surround the joint M. The arrangement of the second LED chips 42 is adjusted according to actual needs. The second LED chips 42 all are the red light LED chips, but this embodiment is not intended to limit the disclosure. That is to say, the second LED chips 42 may partially are the red light LED chips, partially are the blue light LED chips, and partially are the green light LED chips, which may be adjusted according to actual needs.

Referring to FIG. 8, the second LED light source module 110 further includes a reference axis 90. The reference axis 90 and the second surface 54 are parallel. In this embodiment, the first angle θ₁ between the reflected light beam 121 and the reference axis 90 ranges from 0° to 120°, but is not limited to the above-mentioned range, so the reflected light beam 121 is reflected by the reflective surface 72 and emitted from the shell 112. The second angle θ₂ between the direct light beam 122 and the reference axis 90 ranges from 120° to 180°, but is not limited to the above-mentioned range, so the direct light beam 122 is directly emitted from the shell 112.

In this embodiment, the first LED light source module 108 has a first luminous flux L₁, the second LED light source module 110 has a second luminous flux L₂, and the LED bulb 100 further includes a control unit 82, but is not limited thereto. The control unit 82 is used for controlling the first luminous flux L₁ and the second luminous flux L₂. In addition, the first LED light source module 108 also controls, with the control unit 82, the color of the first light beam 11 emitted by each of the first LED chips 32, which, for example, is red, green or blue, but is not limited to the above-mentioned colors. The second LED light source module 110 also controls, with the control unit 82, the color of the second light beam 12 emitted by each of the second LED chips 42, which, for example, is red, green or blue, but is not limited to the above-mentioned colors. When the LED bulb 100 is used for outputting white light, the control unit 82 controls the color of the first light beam 11 emitted by each of the first LED chips 32 and the color of the second light beam 12 emitted by each of the second LED chips 42, so the first light beam 11 and the second light beam 12 are white light beams, but this embodiment is not intended to limit the disclosure. For example, the first package body 30 and the second package body 40 further includes fluorescent powder (not shown) or the shell 112 further includes the fluorescent powder (not shown) or a fluorescent film (not shown), so the control unit 82 controls the color of the first light beam 11 emitted by each of the first LED chip 32 and the color of the second light beam 12 emitted by each second LED chip 42 to be a specific color, and the fluorescent powder excited by the first light beam 11 and the second light beam 12 outputs a light beam having a color which is a complementary color to the specific color, so that the LED bulb 100 outputs the white light.

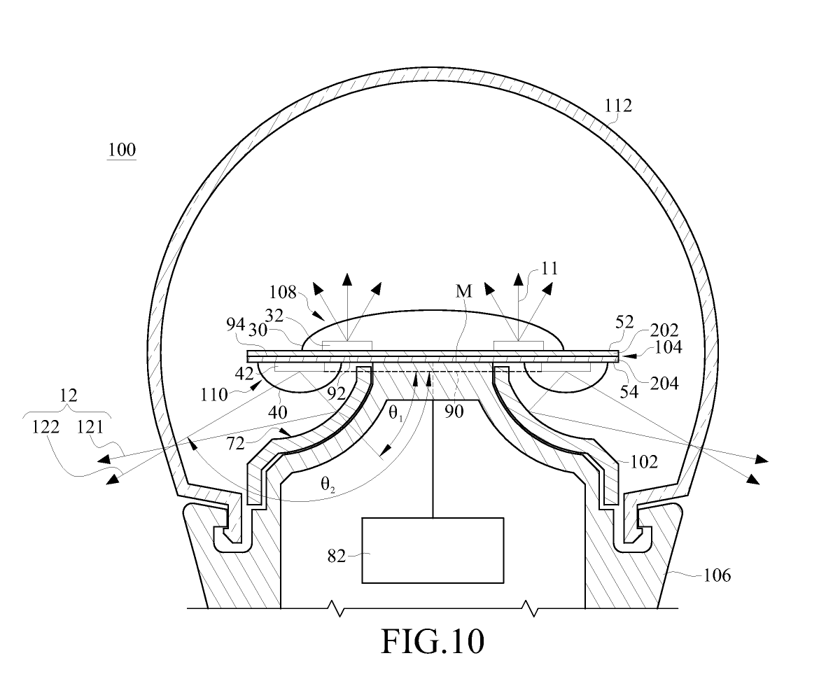

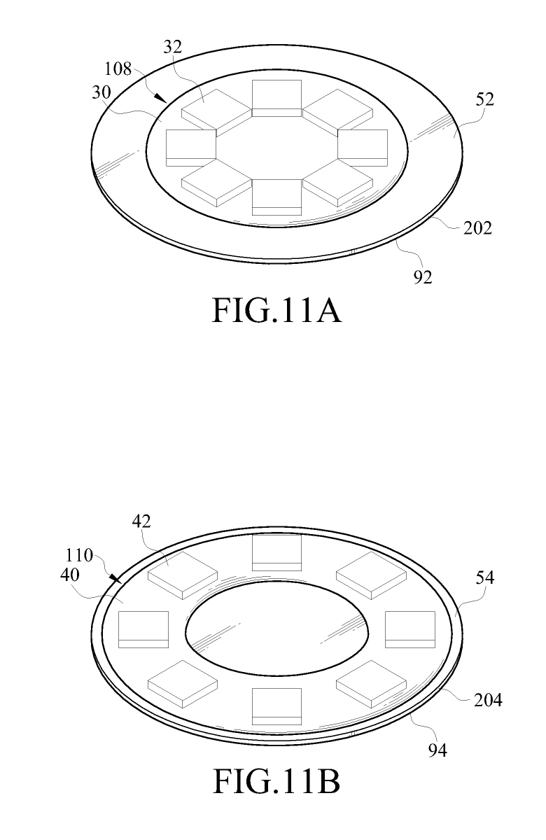

The circuit board assembly 104 according to the fourth embodiment is a double-sided circuit board. In the first LED light source module 108, the first LED chip 32 is disposed between the first package body 30 and the first surface 52 through the COB process. In the second LED light source module 110, the second LED chip 42 is disposed between the second package body 40 and the second surface 54 through the COB process, but the fourth embodiment is not intended to limit the present disclosure. In other words, the circuit board assembly 104 includes the first circuit board 202 and the second circuit board 204, the first circuit board includes the first surface 52 and a third surface 92, the second circuit board 204 includes the second surface 54 and a fourth surface 94, the third surface 92 is opposite to the fourth surface 94 (referring to FIG. 10, FIG. 11A, and FIG. 11B, FIG. 10 is a schematic sectional structural view of the LED bulb according to a fifth embodiment of the disclosure, FIG. 11A is a schematic structural view of the first LED light source module according to an embodiment of in FIG. 10, and FIG. 11B is a schematic structural view of the second LED light source module according to an embodiment in FIG. 10).

Referring to FIG. 10, the first circuit board 202 and the second circuit board 204 respectively are single-sided circuit boards, but are not limited to the above-mentioned circuit boards. Moreover, the third surface 92 of the first circuit board 202 and the fourth surface 94 of the second circuit board 204 superposes to each other.

Referring to FIG. 11A and FIG. 11B, the first LED light source module 108 includes eight first LED chips 32 and the first package body 30, but this embodiment is not intended to limit the disclosure. That is to say, the first LED light source module 108 also includes ten first LED chips 32. The number of the first LED chips 32 included by the first LED light source module 108 may be adjusted according to actual needs. Each of the first LED chips 32 is disposed between the first package body 30 and the first surface 52 (that is, the first LED light source module 108 is disposed on the first surface 52 of the circuit board assembly 104 through the COB process), and the first LED chips 32 are disposed on the first surface 52 in a ring arrangement, but this embodiment is not intended to limit the disclosure. In other words, the first LED chips 32 are be disposed on the first surface 52 in an array arrangement. The arrangement of the first LED chips 32 is adjusted according to actual needs. The first LED chips 32 all are the red light LED chips, but this embodiment is not intended to limit the present disclosure. That is to say, the first LED chips 32 partially are the red light LED chips, partially are the blue light LED chips, and partially are the green light LED chips, which may be adjusted according to actual needs.

The second LED light source module 110 includes eight second LED chips 42 and the second package body 40, but this embodiment is not intended to limit the disclosure. That is to say, the second LED light source module 110 also includes ten second LED chips 42. The number of the second LED chips 42 included by the second LED light source module 110 may be adjusted according to actual needs. Each of the second LED chips 42 is disposed between the second package body 40 and the second surface 54 (that is, the second LED light source module 110 is disposed on the second surface 54 of the circuit board assembly 104 through the COB process), and the second LED chips 42 are arranged in a ring arrangement to surround the joint M, but this embodiment is not intended to limit the disclosure. In other words, the second LED chips 42 are arranged in a square arrangement to surround the joint M. The arrangement of the second LED chips 42 may be adjusted according to actual needs. The second LED chips 42 may all be the red light LED chips, but this embodiment is not intended to limit the disclosure. That is to say, the second LED chips 42 partially are the red light LED chips, partially are the blue light LED chips, and partially are the green light LED chips, which may be adjusted according to actual needs.

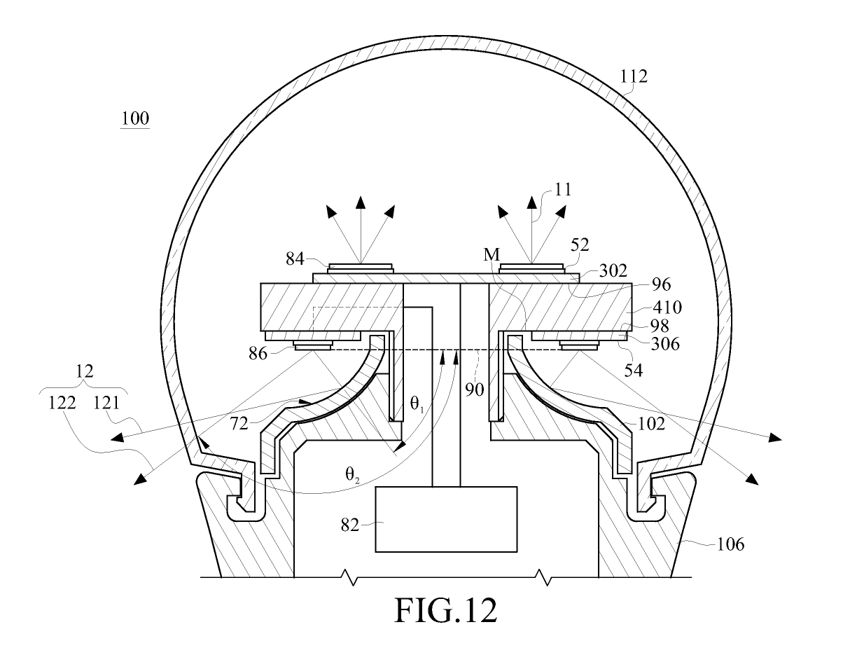

In addition, FIG. 12 is a schematic sectional structural view of the LED bulb according to a sixth embodiment of the disclosure. As shown in FIG. 12, in this embodiment, a LED bulb 100 includes a circuit board assembly 104, a base 106, a first LED light source module 108, a second LED light source module 110, and a shell 112. The base 106 includes a reflective unit 102. The reflective unit 102 has a reflective surface 72. The circuit board assembly 104 includes a first circuit board 302, a second circuit board 306, and a substrate 410. The first circuit board 302 includes a first surface 52 and a third surface 96. The second circuit board 306 includes a second surface 54 and a fourth surface 98. The third surface 96 and the fourth surface 98 are disposed on two opposite side surfaces of the substrate 410. The reflective unit 102 is disposed at the base 106. The first LED light source module 108 is disposed on the first surface 52. The second LED light source module 110 is disposed on the second surface 54, and the second LED light source module 110 surrounds the joint M. The joint M is a joint between the base 106 and the circuit board assembly 104. The shell 112 is joined to the base 106.

The first LED light source module 108 is used for emitting a first light beam 11. The second LED light source module 110 is used for emitting a second light beam 12. The second light beam 12 includes a reflected light beam 121 and a direct light beam 122. The first light beam 11 is directly emitted from the shell 112. The reflected light beam 121 is reflected by the reflective surface 72, and the reflected light beam 121 is emitted from the shell 112. The direct light beam 122 is directly emitted from the shell 112.

The second LED light source module 110 further includes a reference axis 90. The reference axis 90 and the second surface 54 are parallel. In this embodiment, the first angle θ₁ between the reflected light beam 121 and the reference axis 90 ranges from 0° to 120°, but is not limited to the above-mentioned range, so that the reflected light beam 121 is reflected by the reflective surface 72 and emitted from the shell 112. The second angle θ₂ between the direct light beam 122 and the reference axis 90 ranges from 120° to 180°, but is not limited to the above-mentioned range, so that the direct light beam 122 is directly emitted from the shell 112.

In addition, in this embodiment, implementation of the first LED light source module 108 and the second LED light source module 110 are the same as that in the first embodiment (as shown in FIG. 4A and FIG. 4B), so the implementation of this embodiment is not repeated herein.

In addition to that the control unit 82 is used for controlling the first luminous flux L₁, the second luminous flux L₂, the color of the first light beam 11 emitted by each of the first LED package structures 84, the color of the second light beam 12 emitted by each of the second LED package structures 86, the color of the first light beam 11 emitted by each of the first LED chips 32, and the color of the second light beam 12 emitted by each of the second LED chips 42, the control unit 82 may further selectively actuate the first LED light source module 108 or the second LED light source module 110. When the control unit 82 only actuates the first LED light source module 108 (that is, the first LED light source module 108 emits the first light beam 11), the LED bulb according to the disclosure may replace a conventional LED bulb. When the control unit 82 only actuates the second LED light source module 110 (that is, the second LED light source module 110 emits the second light beam 12), the LED bulb according to the disclosure is used for indirect illumination. When the control unit 82 actuates the first LED light source module 108 and the second LED light source module 110 at the same time (that is, the first LED light source module 108 emits the first light beam 11 and the second LED light source module 110 emits the second light beam 12), the LED bulb according to the disclosure may replace a conventional incandescent light bulb.

In the LED bulb according to the disclosure, modification of the design of the reflective surface and the second LED light source module is that the direct light beam and the reflected light beam of the second light beam may compensate for the first light distribution pattern, so the LED bulb according to the disclosure becomes an omni-directional light source. The control unit controls the color of the first light beam emitted by the first LED light source module, the color of the second light beam emitted by the second LED light source module, the ratio between the first luminous flux and the second luminous flux, and selectively actuates the first LED light source module or the second LED light source module. The substrate and the base dissipate the heat generated when the LED bulb is turned on into the ambience. The reflective surface is disposed at the base or the shell. In the first LED light source module, the multiple first LED chips are disposed on the first surface of the circuit board assembly through the COB process, or the multiple first LED package structures are disposed on the first surface of the circuit board assembly. In the second LED light source module, the multiple second LED chips are disposed on the second surface of the circuit board assembly through the COB process, or the multiple second LED package structures are disposed on the second surface of the circuit board assembly.

What is claimed is:

1. A Light Emitting Diode (LED) bulb, comprising:
a circuit board assembly, comprising a first surface and a second surface opposite to each other;
a base, comprising a reflective surface;
a first LED light source module, disposed on the first surface, and used for emitting a first light beam;
a second LED light source module, disposed on the second surface, and used for emitting a second light beam, wherein the second light beam comprises a reflected light beam and a direct light beam; and
a shell, joined to the base;
wherein after passing through the shell, the first light beam forms a first light distribution pattern, after being reflected by the reflective surface and emitted from the shell, the reflected light beam forms a second light distribution pattern, after passing through the shell, the direct light beam forms a third light distribution pattern, and the first light distribution pattern, the second light distribution pattern, and the third light distribution pattern superpose to each other for forming an omni-directional light distribution pattern.

2. The LED bulb according to claim 1, wherein the second LED light source module further has a reference axis, the reference axis and the second surface are parallel, a first angle between the reflected light beam and the reference axis ranges from 0° to 120°, so the reflected light beam is reflected by the reflective surface and emitted from the shell, and a second angle between the direct light beam and the reference axis ranges from 120° to 180°, so the direct light beam is directly emitted from the shell.

3. The LED bulb according to claim 1, wherein the first LED light source module has a first luminous flux, the second LED light source module has a second luminous flux, and a ratio between the first luminous flux and the second luminous flux ranges from 0.1 to 1.5.

4. The LED bulb according to claim 3, wherein the LED bulb further comprises a control unit, and the control unit is used to control the first luminous flux and the second luminous flux.

5. The LED bulb according to claim 1, wherein the first LED light source module comprises a plurality of first LED chips and a first package body, and the first LED chips are disposed between the first package body and the first surface.

6. The LED bulb according to claim 1, wherein the second LED light source module comprises a plurality of second LED chips and a second package body, and the second LED chips are disposed between the second package body and the second surface.

7. The LED bulb according to claim 1, wherein the first LED light source module comprises a plurality of first LED package structures, and the first LED package structures are disposed on the first surface.

8. The LED bulb according to claim 1, wherein the second LED light source module comprises a plurality of second LED package structures, and the second LED package structures are disposed on the second surface.

9. The LED bulb according to claim 1, wherein the circuit board assembly further comprises a first circuit board and a second circuit board, the first circuit board comprises the first surface and a third surface, the second circuit board comprises the second surface and a fourth surface, and the third surface and the fourth surface are opposite to each other.

10. The LED bulb according to claim 1, wherein the circuit board assembly further comprises a first circuit board, a second circuit board, and a substrate, the first circuit board comprises the first surface and a third surface, the second circuit board comprises the second surface and a fourth surface, and the third surface and the fourth surface are disposed on two opposite side surfaces of the substrate.

11. The LED bulb according to claim 10, wherein the substrate is made of aluminum or copper, so the substrate dissipates heat generated by the first circuit board and the second circuit board.

12. The LED bulb according to claim 1, wherein the shell further comprises:
a first shell, joined to the base and the circuit board assembly to form a first accommodation space, wherein the second LED light source module and the reflective surface are disposed in the first accommodation space; and
a second shell, joined to the circuit board assembly to form a second accommodation space, wherein the first LED light source module is disposed in the second accommodation space.

13. The LED bulb according to claim 1, wherein the LED bulb further comprises a control unit, and the control unit selectively actuates the first LED light source module or the second LED light source module.

14. The LED bulb according to claim 1, wherein the LED bulb further comprises a control unit, and the control unit is used for controlling a color of the first light beam or a color of the second light beam.

15. The LED bulb according to claim 1, wherein the base comprises a reflective unit, and the reflective unit has the reflective surface.

16. A Light Emitting Diode (LED) bulb, comprising:
a circuit board assembly, comprising a first surface and a second surface opposite to each other;
a base;
a first LED light source module, disposed on the first surface, and used for emitting a first light beam;
a second LED light source module, disposed on the second surface, and used for emitting a second light beam, wherein the second light beam comprises a reflected light beam and a direct light beam; and
a shell, joined to the base, and comprising a reflective surface;
wherein after passing through the shell, the first light beam forms a first light distribution pattern, after being reflected by the reflective surface and emitted from the shell, the reflected light beam forms a second light distribution pattern, after passing through the shell, the direct light beam forms a third light distribution pattern, and the first light distribution pattern, the second light distribution pattern, and the third light distribution pattern superpose to each other to form an omni-directional light distribution pattern.

17. The LED bulb according to claim 16, wherein the shell further comprises:
a first shell, joined to the base and the circuit board assembly to form a first accommodation space, wherein the second LED light source module and the reflective surface are disposed in the first accommodation space; and
a second shell, joined to the circuit board assembly to form a second accommodation space, wherein the first LED light source module is disposed in the second accommodation space.

18. The LED bulb according to claim 16, wherein the first LED light source module has a first luminous flux, the second LED light source module has a second luminous flux, and a ratio between the first luminous flux and the second luminous flux ranges from 0.1 to 1.5.

19. The LED bulb according to claim 18, wherein the LED bulb further comprises a control unit, and the control unit is used for controlling the first luminous flux and the second luminous flux.

20. The LED bulb according to claim 16, wherein the circuit board assembly further comprises a first circuit board, a second circuit board, and a substrate, the first circuit board comprises the first surface and a third surface, the second circuit board comprises the second surface and a fourth surface, and the third surface and the fourth surface are disposed on two opposite side surfaces of the substrate.

21. The LED bulb according to claim 20, wherein the substrate is made of aluminum or copper, so the substrate dissipates heat generated by the first circuit board and the second circuit board.

22. The LED bulb according to claim 16, wherein the LED bulb further comprises a control unit, and the control unit selectively actuates the first LED light source module or the second LED light source module.

23. The LED bulb according to claim 16, wherein the LED bulb further comprises a control unit, and the control unit is used for controlling a color of the first light beam or a color of the second light beam.
